(19) United States
(12) Patent Application Publication
(10) Pub. No.: US 2025/0192963 A1
(43) Pub. Date: Jun. 12, 2025

(54) METHOD AND DEVICE FOR TRANSMITTING OR RECEIVING IMPROVED CODEBOOK-BASED CHANNEL STATE INFORMATION IN WIRELESS COMMUNICATION SYSTEM

(71) Applicant: LG ELECTRONICS INC., Seoul (KR)

(72) Inventors: Haewook PARK, Seoul (KR); Jiwon KANG, Seoul (KR); Kyuseok KIM, Seoul (KR)

(21) Appl. No.: 18/845,765

(22) PCT Filed: Mar. 28, 2023
(86) PCT No.: PCT/KR2023/004062

§ 371 Date: Sep. 10, 2024

(30) Foreign Application Priority Data
Mar. 28, 2022 (KR) 10-2022-0037808

(51) Int. Cl. H04L 5/00; H04L 41/16

(52) U.S. Cl. CPC H04L 5/0057; H04L 5/0048; H04L 41/16

(57) ABSTRACT

A method and device for transmitting or receiving improved codebook-based channel state information in a wireless communication system are disclosed. A method performed by a terminal in a wireless communication system, according to one embodiment of the present disclosure, comprises the steps of: receiving one or more channel state information (CSI)-reference signals (RS) from a network; and transmitting, to the network, one or more CSI reports including information indicating a first precoding matrix based on the one or more CSI-RSs and a channel quality indicator (CQI) based on a second precoding matrix, wherein the first precoding matrix is included in a set of precoding matrices defined on the basis of one or more predetermined codebooks, and the second precoding matrix can be determined on the basis of the first precoding matrix and one or more pieces of artificial intelligence (AI)/machine learning (ML) model-related information.

### CROSS-REFERENCE TO RELATED APPLICATIONS

This application is the National Stage filing under 35 U.S.C. 371 of International Application No. PCT/KR2023/004062, filed on Mar. 28, 2023, which claims the benefit of earlier filing date and right of priority to KR application No. 10-2022-0037808, filed on Mar. 28, 2022, the contents of which are all hereby incorporated by reference herein in their entireties.

### TECHNICAL FIELD

The present disclosure relates to a wireless communication system, and more particularly, to a method and a device for transmitting or receiving enhanced codebook-based channel state information in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

A technical problem of the present disclosure is to provide a method and a device for transmitting or receiving enhanced codebook-based channel state information (CSI) distinguished from CSI based on a codebook defined/shared in advance between a base station and a terminal in a wireless communication system.

An additional technical problem of the present disclosure is to provide a method and a device for reporting at least one of codebook-based CSI or enhanced codebook-based CSI from a terminal to a base station in a wireless communication system.

The technical objects to be achieved by the present disclosure are not limited to the above-described technical objects, and other technical objects which are not described herein will be clearly understood by those skilled in the pertinent art from the following description.

A method performed by a terminal in a wireless communication system according to an aspect of the present disclosure includes receiving at least one channel state information (CSI)-reference signal (RS) from a network; and transmitting, to the network, at least one CSI report including information indicating a first precoding matrix based on the at least one CSI-RS and a channel quality indicator (CQI) based on a second precoding matrix, wherein the first precoding matrix may be included in a set of precoding matrices defined based on at least one predetermined codebook, and the second precoding matrix may be determined based on the first precoding matrix and at least one artificial intelligence (AI)/machine learning (ML) model-related information.

A method performed by a base station in a wireless communication system according to an additional aspect of the present disclosure includes transmitting, to a terminal, at least one channel state information (CSI)-reference signal (RS); and receiving, from the terminal, at least one CSI report including information indicating a first precoding matrix based on the at least one CSI-RS and a channel quality indicator (CQI) based on a second precoding matrix, wherein the first precoding matrix may be included in a set of precoding matrices defined based on at least one predetermined codebook, and the second precoding matrix may be determined based on the first precoding matrix and at least one artificial intelligence (AI)/machine learning (ML) model-related information.

According to the present disclosure, a method and a device for transmitting or receiving enhanced codebook-based channel state information (CSI) distinguished from CSI based on a codebook defined/shared in advance between a base station and a terminal in a wireless communication system may be provided.

According to the present disclosure, a method and a device for reporting at least one of codebook-based CSI or enhanced codebook-based CSI from a terminal to a base station in a wireless communication system may be provided.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 illustrates a classification of artificial intelligence.

FIG. 8 illustrates a feed-forward neural network.

FIG. 9 illustrates a recurrent neural network.

FIG. 10 illustrates a convolutional neural network.

FIG. 11 illustrates an auto encoder.

FIG. 12 illustrates a functional framework for an AI operation.

FIG. 13 is a diagram illustrating split AI inference.

FIG. 14 illustrates an application of a functional framework in a wireless communication system.

FIG. 15 illustrates an application of a functional framework in a wireless communication system.

FIG. 16 illustrates an application of a functional framework in a wireless communication system.

FIG. 17 is a diagram illustratively showing an operation of a base station and a terminal for AI/ML-enhanced CSI feedback to which the present disclosure may be applied.

FIG. 18 is a diagram for describing codebook-based and enhanced codebook-based CSI feedback to which the present disclosure may be applied.

FIG. 19 is a diagram for describing an example of an enhanced codebook-based CSI transmission method of a terminal according to the present disclosure.

FIG. 20 is a diagram for describing an example of an enhanced codebook-based CSI reception method of a base station according to the present disclosure.

FIG. 21 illustrates a block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB(evolved-NodeB), a gNB(Next Generation NodeB), a BTS(base transceiver system), an Access Point(AP), a Network(5G network), an AI(Artificial Intelligence) system/module, an RSU(road side unit), a robot, a drone(UAV: Unmanned Aerial Vehicle), an AR(Augmented Reality) device, a VR(Virtual Reality) device, etc. In addition, a terminal may be fixed or mobile, and may be substituted with a term such as a UE(User Equipment), an MS(Mobile Station), a UT(user terminal), an MSS(Mobile Subscriber Station), an SS(Subscriber Station), an AMS(Advanced Mobile Station), a WT(Wireless terminal), an MTC(Machine-Type Communication) device, an M2M(Machine-to-Machine) device, a D2D(Device-to-Device) device, a vehicle, an RSU(road side unit), a robot, an AI(Artificial Intelligence) module, a drone(UAV: Unmanned Aerial Vehicle), an AR(Augmented Reality) device, a VR(Virtual Reality) device, etc.

The following description may be used for a variety of radio access systems such as CDMA, FDMA, TDMA, OFDMA, SC-FDMA, etc. CDMA may be implemented by a wireless technology such as UTRA(Universal Terrestrial Radio Access) or CDMA2000. TDMA may be implemented by a radio technology such as GSM(Global System for Mobile communications)/GPRS(General Packet Radio Service)/EDGE(Enhanced Data Rates for GSM Evolution). OFDMA may be implemented by a radio technology such as IEEE 802.11(Wi-Fi), IEEE 802.16(WiMAX), IEEE 802-20, E-UTRA(Evolved UTRA), etc. UTRA is a part of a UMTS(Universal Mobile Telecommunications System). 3GPP(3rd Generation Partnership Project) LTE(Long Term Evolution) is a part of an E-UMTS(Evolved UMTS) using E-UTRA and LTE-A(Advanced)/LTE-A pro is an advanced version of 3GPP LTE. 3GPP NR(New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS(Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211(physical channels and modulation), TS 36.212(multiplexing and channel coding), TS 36.213(physical layer procedures), TS 36.300(overall description), TS 36.331(radio resource control) may be referred to.

For 3GPP NR, TS 38.211(physical channels and modulation), TS 38.212(multiplexing and channel coding), TS 38.213(physical layer procedures for control), TS 38.214(physical layer procedures for data), TS 38.300(NR and NG-RAN(New Generation-Radio Access Network) overall description), TS 38.331(radio resource control protocol specification) may be referred to.

Abbreviations of terms which may be used in the present disclosure is defined as follows.
BM: beam management
CQI: Channel Quality Indicator
CRI: channel state information—reference signal resource indicator
CSI: channel state information
CSI-IM: channel state information—interference measurement
CSI-RS: channel state information—reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))

TDM: time division multiplexing

TRP: transmission and reception point

TRS: tracking reference signal

Tx: transmission

UE: user equipment

ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB(enhanced mobile broadband communication), mMTC(massive MTC), URLLC(Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

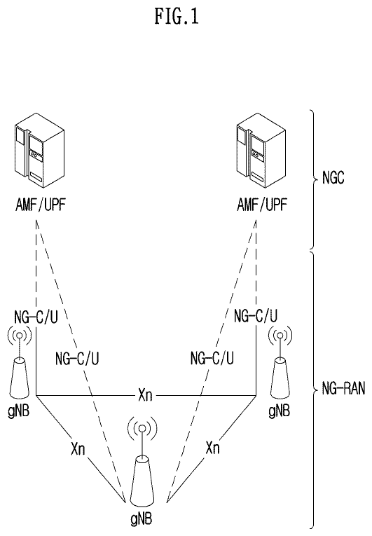

FIG. 1 illustrates a structure of a wireless communication system to which the present disclosure may be applied.

In reference to FIG. 1, NG-RAN is configured with gNBs which provide a control plane (RRC) protocol end for a NG-RA(NG-Radio Access) user plane (i.e., a new AS(access stratum) sublayer/PDCP(Packet Data Convergence Protocol)/RLC(Radio Link Control)/MAC/PHY) and UE. The gNBs are interconnected through a Xn interface. The gNB, in addition, is connected to an NGC(New Generation Core) through an NG interface. In more detail, the gNB is connected to an AMF(Access and Mobility Management Function) through an N2 interface, and is connected to a UPF(User Plane Function) through an N3 interface.

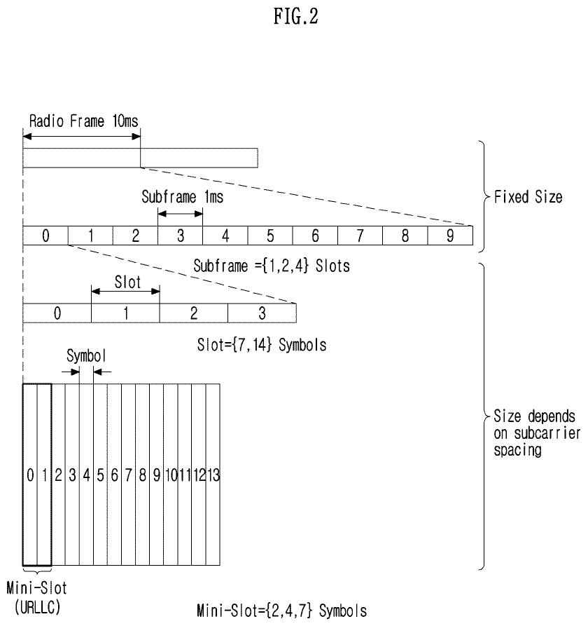

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, p). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | Subcarrier |
|---|---|---|
| designation | frequency range | Spacing |
| FR1 | 410 MHz- | 15, 30, 60 kHz |
| | 7125 MHz | |
| FR2 | 24250 MHz- | 60, 120, 240 kHz |
| | 52600 MHz | |

Regarding a frame structure in an NR system, a size of a variety of fields in a time domain is expresses as a multiple of a time unit of T_{c}=1/(Δfₘₐₓ·N^{f}). Here, Δfₘₐₓ is 480·10³ Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe,μ}} in a subframe and are numbered in an increasing order of n_{s,f}^{μ∈{}0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

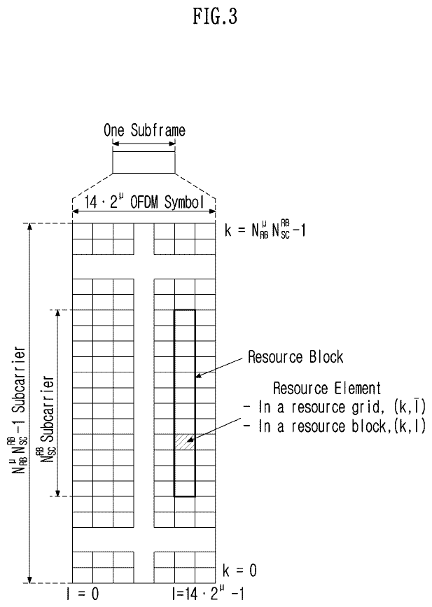

FIG. 2 is an example on μ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail. First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL(quasi co-located or quasi co-location) relationship. In this case, the large-scale property includes at least one of delay spread, doppler spread, frequency shift, average received power, received timing. FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per p and antenna port p. Each element of a resource grid for μ and an antenna port p is referred to as a resource element and is uniquely identified by an index pair (k,l′). Here, k=0, . . . ,N_{RB}^{μ}N_{sc}^{RB}−1 is an index in a frequency domain and 1′=0, . . . ,2^{μ}N_{symb}^{(μ)}−1 refers to a position of a symbol in a subframe. When referring to a resource element in a slot, an index pair (k,l) is used. Here, 1=0, . . . ,N_{symb}^{μ}−1. A resource element (k,l′) for μ and an antenna port p corresponds to a complex value, a_{k,l}′. When there is no risk of confusion or when a specific antenna port or numerology is not specified, indexes p and p may be dropped, whereupon a complex value may be a_{k,l}^{(p)} or a_{k,l}′. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

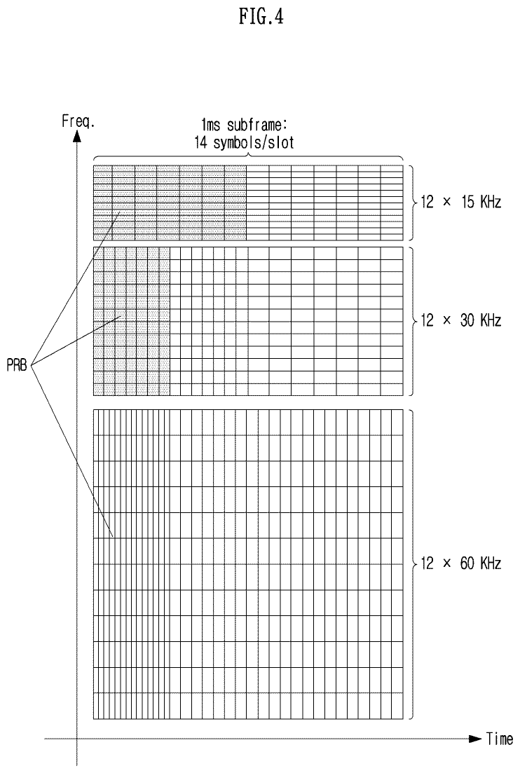

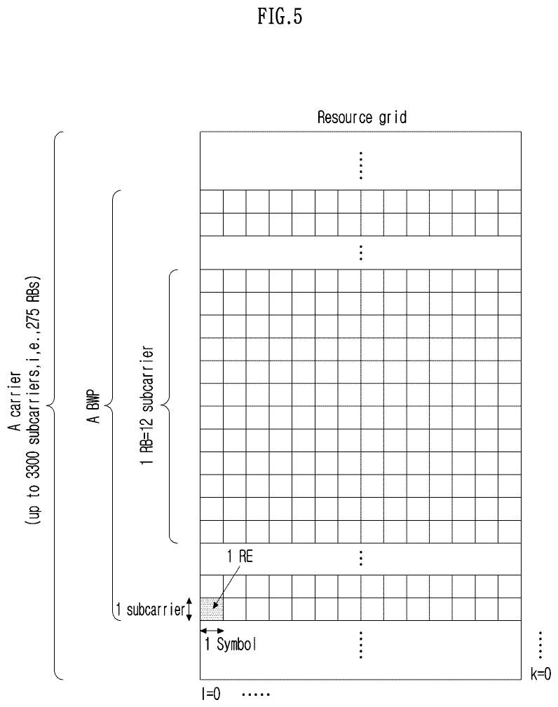

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP(Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE(Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

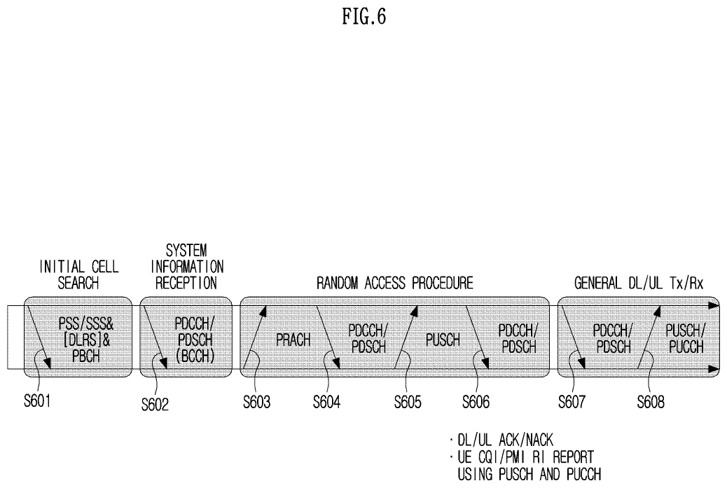

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH(Physical Uplink Shared Channel)/PUCCH(physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK(Acknowledgement/Non-Acknowledgement) signal, a CQI(Channel Quality Indicator), a PMI(Precoding Matrix Indicator), a RI(Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL(Supplementary UL), frequency resource allocation, time resource allocation, frequency hopping, etc.), information related to a transport block(TB) (e.g., MCS(Modulation Coding and Scheme), a NDI(New Data Indicator), a RV(Redundancy Version), etc.), information related to a HARQ(Hybrid-Automatic Repeat and request) (e.g., a process number, a DAI(Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI(Cell Radio Network Temporary Identifier) or a CS-RNTI(Configured Scheduling RNTI) or a MCS-C-RNTI(Modulation Coding Scheme Cell RNTI) and transmitted. DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI(Semi-Persistent CSI RNTI) or a MCS-C-RNTI and transmitted. DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB(virtual resource block)-PRB(physical resource block) mapping, etc.), information related to a transport block(TB) (e.g., MCS, NDI, RV, etc.), information related to a HARQ (e.g., a process number, DAI, PDSCH-HARQ feedback timing, etc.), information related to multiple antennas (e.g., an antenna port, a TCI(transmission configuration indicator), a SRS(sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### CSI-Related Operation

In an NR (New Radio) system, a CSI-RS(channel state information-reference signal) is used for time and/or frequency tracking, CSI computation, L1(layer 1)-RSRP(reference signal received power) computation and mobility. Here, CSI computation is related to CSI acquisition and L1-RSRP computation is related to beam management (BM).

CSI(channel state information) collectively refers to information which may represent quality of a radio channel (or also referred to as a link) formed between a terminal and an antenna port.

To perform one of the usages of a CSI-RS, a terminal (e.g., user equipment, UE) receives configuration information related to CSI from a base station (e.g., general Node B, gNB) through RRC(radio resource control) signaling.

The configuration information related to CSI may include at least one of information related to a CSI-IM (interference management) resource, information related to CSI measurement configuration, information related to CSI resource configuration, information related to a CSI-RS resource or information related to CSI report configuration.
i) Information related to a CSI-IM resource may include CSI-IM resource information, CSI-IM resource set information, etc. A CSI-IM resource set is identified by a CSI-IM resource set ID (identifier) and one resource set includes at least one CSI-IM resource. Each CSI-IM resource is identified by a CSI-IM resource ID.
ii) Information related to CSI resource configuration may be expressed as CSI-ResourceConfig IE. Information related to a CSI resource configuration defines a group which includes at least one of an NZP(non zero power) CSI-RS resource set, a CSI-IM resource set or a CSI-SSB resource set. In other words, the information related to a CSI resource configuration may include a CSI-RS resource set list and the CSI-RS resource set list may include at least one of a NZP CSI-RS resource set list, a CSI-IM resource set list or a CSI-SSB resource set list. A CSI-RS resource set is identified by a CSI-RS resource set ID and one resource set includes at least one CSI-RS resource. Each CSI-RS resource is identified by a CSI-RS resource ID.

Parameters representing a usage of a CSI-RS (e.g., a ‘repetition’ parameter related to BM, a ‘trs-Info’ parameter related to tracking) may be configured per NZP CSI-RS resource set.
iii) Information related to a CSI report configuration includes a report configuration type (reportConfigType) parameter representing a time domain behavior and a report quantity (reportQuantity) parameter representing CSI-related quantity for a report. The time domain behavior may be periodic, aperiodic or semi-persistent.
A terminal measures CSI based on the configuration information related to CSI.

The CSI measurement may include (1) a process in which a terminal receives a CSI-RS and (2) a process in which CSI is computed through a received CSI-RS and detailed description thereon is described after.

For a CSI-RS, RE(resource element) mapping of a CSI-RS resource in a time and frequency domain is configured by higher layer parameter CSI-RS-ResourceMapping.

A terminal reports the measured CSI to a base station.

In this case, when quantity of CSI-ReportConfig is configured as ‘none (or No report)’, the terminal may omit the report. But, although the quantity is configured as ‘none (or No report)’, the terminal may perform a report to a base station. When the quantity is configured as ‘none’, an aperiodic TRS is triggered or repetition is configured. In this case, only when repetition is configured as ‘ON’, a report of the terminal may be omitted.

### CSI Measurement

An NR system supports more flexible and dynamic CSI measurement and reporting. Here, the CSI measurement may include a procedure of receiving a CSI-RS and acquiring CSI by computing a received CSI-RS.

As a time domain behavior of CSI measurement and reporting, aperiodic/semi-persistent/periodic CM (channel measurement) and IM (interference measurement) are supported. 4-port NZP CSI-RS RE pattern is used for CSI-IM configuration.

CSI-IM based IMR of NR has a design similar to CSI-IM of LTE and is configured independently from ZP CSI-RS resources for PDSCH rate matching. In addition, each port emulates an interference layer having (a desirable channel and) a precoded NZP CSI-RS in NZP CSI-RS-based IMR. As it is about intra-cell interference measurement for a multi-user case, MU interference is mainly targeted.

A base station transmits a precoded NZP CSI-RS to a terminal in each port of configured NZP CSI-RS based IMR.

A terminal assumes a channel/interference layer and measures interference for each port in a resource set.

When there is no PMI and RI feedback for a channel, a plurality of resources are configured in a set and a base station or a network indicates a subset of NZP CSI-RS resources through DCI for channel/interference measurement.

A resource setting and a resource setting configuration are described in more detail.

### Resource Setting

Each CSI resource setting ‘CSI-ResourceConfig’ includes a configuration for a S≥1 CSI resource set (given by a higher layer parameter csi-RS-ResourceSetList). A CSI resource setting corresponds to CSI-RS-resourcesetlist. Here, S represents the number of configured CSI-RS resource sets. Here, a configuration for a S≥1 CSI resource set includes each CSI resource set including CSI-RS resources (configured with a NZP CSI-RS or CSI-IM) and a SS/PBCH block (SSB) resource used for L1-RSRP computation.

Each CSI resource setting is positioned at a DL BWP(bandwidth part) identified by a higher layer parameter bwp-id. In addition, all CSI resource settings linked to a CSI reporting setting have the same DL BWP.

A time domain behavior of a CSI-RS resource in a CSI resource setting included in a CSI-ResourceConfig IE may be indicated by a higher layer parameter resourceType and may be configured to be aperiodic, periodic or semi-persistent. For a periodic and semi-persistent CSI resource setting, the number (S) of configured CSI-RS resource sets is limited to ‘1’. For a periodic and semi-persistent CSI resource setting, configured periodicity and a slot offset are given by a numerology of an associated DL BWP as given by bwp-id.

When UE is configured with a plurality of CSI-ResourceConfigs including the same NZP CSI-RS resource ID, the same time domain behavior is configured for CSI-ResourceConfig.

When UE is configured with a plurality of CSI-ResourceConfigs including the same CSI-IM resource ID, the same time domain behavior is configured for CSI-ResourceConfig.

One or more CSI resource settings for channel measurement (CM) and interference measurement (IM) are configured through higher layer signaling as follows.
CSI-IM resource for interference measurement
NZP CSI-RS resource for interference measurement
NZP CSI-RS resource for channel measurement

In other words, a CMR (channel measurement resource) may be a NZP CSI-RS for CSI acquisition and an IMR(Interference measurement resource) may be a NZP CSI-RS for CSI-IM and IM.

In this case, CSI-IM(or a ZP CSI-RS for IM) is mainly used for inter-cell interference measurement.

In addition, an NZP CSI-RS for IM is mainly used for intra-cell interference measurement from multi-users.

UE may assume that CSI-RS resource(s) for channel measurement and CSI-IM/NZP CSI-RS resource(s) for interference measurement configured for one CSI reporting are ‘QCL-TypeD’ per resource.

### Resource Setting Configuration

As described, a resource setting may mean a resource set list.

For aperiodic CSI, each trigger state configured by using a higher layer parameter CSI-AperiodicTriggerState is associated with one or a plurality of CSI-ReportConfigs that each CSI-ReportConfig is linked to a periodic, semi-persistent or aperiodic resource setting.

One reporting setting may be connected to up to 3 resource settings.
When one resource setting is configured, a resource setting (given by a higher layer parameter resourcesForChannelMeasurement) is about channel measurement for L1-RSRP computation.
When two resource settings are configured, a first resource setting (given by a higher layer parameter resourcesForChannelMeasurement) is for channel measurement and a second resource setting (given by csi-IM-ResourcesForlnterference or nzp-CSI-RS-ResourcesForInterference) is for interference measurement performed in CSI-IM or a NZP CSI-RS.
When three resource settings are configured, a first resource setting (given by resourcesForChannelMeasurement) is for channel measurement, a second resource setting (given by csi-IM-ResourcesForlnterference) is for CSI-IM based interference measurement and a third resource setting (given by nzp-CSI-RS-ResourcesForInterference) is for NZP CSI-RS based interference measurement.

For semi-persistent or periodic CSI, each CSI-ReportConfig is linked to a periodic or semi-persistent resource setting.
When one resource setting (given by resourcesForChannelMeasurement) is configured, the resource setting is about channel measurement for L1-RSRP computation.
When two resource settings are configured, a first resource setting (given by resourcesForChannelMeasurement) is for channel measurement and a second resourece setting (given by a higher layer parameter csi-IM-ResourcesForlnterference) is used for interference measurement performed in CSI-IM.

### CSI Computation

When interference measurement is performed in CSI-IM, each CSI-RS resource for channel measurement is associated with a CSI-IM resource per resource in an order of CSI-RS resources and CSI-IM resources in a corresponding resource set. The number of CSI-RS resources for channel measurement is the same as the number of CSI-IM resources.

In addition, when interference measurement is performed in an NZP CSI-RS, UE does not expect to be configured with one or more NZP CSI-RS resources in an associated resource set in a resource setting for channel measurement.

A terminal configured with a higher layer parameter nzp-CSI-RS-ResourcesForInterference does not expect that 18 or more NZP CSI-RS ports will be configured in a NZP CSI-RS resource set.

For CSI measurement, a terminal assumes the followings.
Each NZP CSI-RS port configured for interference measurement corresponds to an interference transmission layer.
All interference transmission layers of an NZP CSI-RS port for interference measurement consider EPRE (energy per resource element) ratio.
A different interference signal in RE(s) of an NZP CSI-RS resource for channel measurement, an NZP CSI-RS resource for interference measurement or a CSI-IM resource for interference measurement

### CSI Report

For a CSI report, a time and frequency resource which may be used by UE are controlled by a base station.

CSI(channel state information) may include at least one of a channel quality indicator(CQI), a precoding matrix indicator(PMI), a CSI-RS resource indicator (CRI), a SS/PBCH block resource indicator (SSBRI), a layer indicator (LI), a rank indicator (RI) or L1-RSRP.

For CQI, PMI, CRI, SSBRI, L1, RI, L1-RSRP, a terminal is configured by a higher layer with N≥1 CSI-ReportConfig reporting setting, M≥1 CSI-ResourceConfig resource setting and a list of one or two trigger states (provided by aperiodicTriggerStateList and semiPersistentOnPUSCH-TriggerStateList). Each trigger state in the aperiodicTriggerStateList includes a associated CSI-ReportConfigs list which indicates a channel and optional resource set IDs for interference. In semiPersistentOnPUSCH-TriggerStateList, one associated CSI-ReportConfig is included in each trigger state.

In addition, a time domain behavior of CSI reporting supports periodic, semi-persistent, aperiodic.
i) Periodic CSI reporting is performed in a short PUCCH, a long PUCCH. Periodicity and a slot offset of periodic CSI reporting may be configured by RRC and refers to a CSI-ReportConfig IE.
ii) SP(semi-periodic) CSI reporting is performed in a short PUCCH, a long PUCCH, or a PUSCH.

For SP CSI in a short/long PUCCH, periodicity and a slot offset are configured by RRC and a CSI report is activated/deactivated by separate MAC CE/DCI.

For SP CSI in a PUSCH, periodicity of SP CSI reporting is configured by RRC, but a slot offset is not configured by RRC and SP CSI reporting is activated/deactivated by DCI(format 0_1). For SP CSI reporting in a PUSCH, a separated RNTI(SP-CSI C-RNTI) is used.

An initial CSI report timing follows a PUSCH time domain allocation value indicated by DCI and a subsequent CSI report timing follows a periodicity configured by RRC.

DCI format 0_1 may include a CSI request field and activate/deactivate a specific configured SP-CSI trigger state. SP CSI reporting has activation/deactivation equal or similar to a mechanism having data transmission in a SPS PUSCH.
iii) Aperiodic CSI reporting is performed in a PUSCH and is triggered by DCI. In this case, information related to trigger of aperiodic CSI reporting may be delivered/indicated/configured through MAC-CE.

For AP CSI having an AP CSI-RS, AP CSI-RS timing is configured by RRC and timing for AP CSI reporting is dynamically controlled by DCI.

In NR, a method of dividing and reporting CSI in a plurality of reporting instances applied to a PUCCH based CSI report in LTE (e.g., transmitted in an order of RI, WB PMI/CQI, SB PMI/CQI) is not applied. Instead, in NR, there is a limit that a specific CSI report is not configured in a short/long PUCCH and a CSI omission rule is defined. In addition, regarding AP CSI reporting timing, a PUSCH symbol/slot location is dynamically indicated by DCI. In addition, candidate slot offsets are configured by RRC. For CSI reporting, a slot offset(Y) is configured per reporting setting. For UL-SCH, a slot offset K2 is separately configured.

2 CSI latency classes (low latency class, high latency class) are defined with regard to CSI computation complexity. Low latency CSI is WB CSI which includes up to 4 ports Type-I codebooks or up to 4 ports non-PMI feedback CSI. High latency CSI refers to CSI other than low latency CSI. For a normal terminal, (Z, Z′) is defined in a unit of OFDM symbols. Here, Z represents the minimum CSI processing time until a CSI report is performed after receiving aperiodic CSI triggering DCI. In addition, Z′ refers to the minimum CSI processing time until a CSI report is performed after receiving a CSI-RS for a channel/interference.

Additionally, a terminal reports the number of CSI which may be calculated at the same time.

### Quasi-Co Location (OCL)

An antenna port is defined so that a channel where a symbol in an antenna port is transmitted can be inferred from a channel where other symbol in the same antenna port is transmitted. When a property of a channel where a symbol in one antenna port is carried may be inferred from a channel where a symbol in other antenna port is carried, it may be said that 2 antenna ports are in a QC/QCL(quasi co-located or quasi co-location) relationship.

Here, the channel property includes at least one of delay spread, doppler spread, frequency/doppler shift, average received power, received timing/average delay, or a spatial RX parameter. Here, a spatial Rx parameter means a spatial (Rx) channel property parameter such as an angle of arrival.

A terminal may be configured at list of up to M TCI-State configurations in a higher layer parameter PDSCH-Config to decode a PDSCH according to a detected PDCCH having intended DCI for a corresponding terminal and a given serving cell. The M depends on UE capability.

Each TCI-State includes a parameter for configuring a quasi co-location relationship between ports of one or two DL reference signals and a DM-RS(demodulation reference signal) of a PDSCH.

A quasi co-location relationship is configured by a higher layer parameter qcl-Type1 for a first DL RS and qcl-Type2 for a second DL RS (if configured). For two DL RSs, a QCL type is not the same regardless of whether a reference is a same DL RS or a different DL RS.

A QCL type corresponding to each DL RS is given by a higher layer parameter qcl-Type of QCL-Info and may take one of the following values.

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, it may be indicated/configured that a corresponding NZP CSI-RS antenna port is quasi-colocated with a specific TRS with regard to QCL-Type A and is quasi-colocated with a specific SSB with regard to QCL-Type D. A terminal received such indication/configuration may receive a corresponding NZP CSI-RS by using a doppler, delay value measured in a QCL-TypeA TRS and apply a Rx beam used for receiving QCL-TypeD SSB to reception of a corresponding NZP CSI-RS.

UE may receive an activation command by MAC CE signaling used to map up to 8 TCI states to a codepoint of a DCI field ‘Transmission Configuration Indication’.

When HARQ-ACK corresponding to a PDSCH carrying an activation command is transmitted in a slot n, mapping indicated between a TCI state and a codepoint of a DCI field ‘Transmission Configuration Indication’ may be applied by starting from a slot n+3Nₛₗₒₜ^{subframe,μ}+1. After UE receives an initial higher layer configuration for TCI states before receiving an activation command, UE may assume for QCL-TypeA, and if applicable, for QCL-TypeD that a DMRS port of a PDSCH of a serving cell is quasi-colocated with a SS/PBCH block determined in an initial access process.

When a higher layer parameter (e.g., tci-PresentInDCI) indicating whether there is a TCI field in DCI configured for UE is set to be enabled for a CORESET scheduling a PDSCH, UE may assume that there is a TCI field in DCI format 1_1 of a PDCCH transmitted in a corresponding CORESET. When tci-PresentInDCI is not configured for a CORESET scheduling a PDSCH or when a PDSCH is scheduled by DCI format 1_0 and a time offset between reception of DL DCI and a corresponding PDSCH is equal to or greater than a predetermined threshold (e.g., timeDurationForQCL), in order to determine a PDSCH antenna port QCL, UE may assume that a TCI state or a QCL assumption for a PDSCH is the same as a TCI state or a QCL assumption applied to a CORESET used for PDCCH transmission. Here, the predetermined threshold may be based on reported UE capability.

When a parameter tci-PresentInDCI is set to be enabled, a TCI field in DCI in a scheduling CC (component carrier) may indicate an activated TCI state of a scheduled CC or a DL BWP. When a PDSCH is scheduled by DCI format 1_1, UE may use a TCI-state according to a value of a ‘Transmission Configuration Indication’ field of a detected PDCCH having DCI to determine a PDSCH antenna port QCL.

When a time offset between reception of DL DCI and a corresponding PDSCH is equal to or greater than a predetermined threshold (e.g., timeDurationForQCL), UE may assume that a DMRS port of a PDSCH of a serving cell is quasi-colocated with RS(s) in a TCI state for QCL type parameter(s) given by an indicated TCI state.

When a single slot PDSCH is configured for UE, an indicated TCI state may be based on an activated TCI state of a slot having a scheduled PDSCH.

When multiple-slot PDSCHs are configured for UE, an indicated TCI state may be based on an activated TCI state of a first slot having a scheduled PDSCH and UE may expect that activated TCI states across slots having a scheduled PDSCH are the same.

When a CORESET associated with a search space set for cross-carrier scheduling is configured for UE, UE may expect that a tci-PresentInDCI parameter is set to be enabled for a corresponding CORESET. When one or more TCI states are configured for a serving cell scheduled by a search space set including QCL-TypeD, UE may expect that a time offset between reception of a PDCCH detected in the search space set and a corresponding PDSCH is equal to or greater than a predetermined threshold (e.g., timeDurationForQCL).

For both of a case in which a parameter tci-PresentInDCI is set to be enabled and a case in which tci-PresentInDCI is not configured in a RRC connected mode, when a time offset between reception of DL DCI and a corresponding PDSCH is less than a predetermined threshold (e.g., timeDurationForQCL), UE may assume that a DMRS port of a PDSCH of a serving cell is quasi-colocated with RS(s) for QCL parameter(s) used for PDCCH QCL indication of a CORESET associated with a monitored search space having the lowest CORESET-ID in the latest slot where one or more CORESETs in an activated BWP of a serving cell is monitored by UE.

In this case, when QCL-TypeD of a PDSCH DMRS is different from QCL-TypeD of a PDCCH DMRS and they are overlapped in at least one symbol, UE may expect that reception of a PDCCH associated with a corresponding CORESET will be prioritized. It may be also applied to intra-band CA (carrier aggregation) (when a PDSCH and a CORESET exist in a different CC). When any of configured TCI states does not include QCL-TypeD, a different QCL assumption may be obtained from TCI states indicated for a scheduled PDSCH, regardless of a time offset between reception of DL DCI and a corresponding PDSCH.

For a periodic CSI-RS resource of configured NZP-CSI-RS-ResourceSet including a higher layer parameter trs-Info, UE may expect a TCI state to indicate one of the following QCL type(s).
QCL-TypeC with a SS/PBCH block, and if applicable, QCL-TypeD with the same SS/PBCH block, or
QCL-TypeC with a SS/PBCH block, and if applicable, QCL-TypeD with a CSI-RS resource in configured NZP-CSI-RS-ResourceSet including a higher layer parameter repetition

For an aperiodic CSI-RS resource of configured NZP-CSI-RS-ResourceSet including a higher layer parameter trs-Info, UE may expect a TCI state to indicate QCL-TypeA with a periodic CSI-RS resource of NZP-CSI-RS-ResourceSet including a higher layer parameter trs-Info, and if applicable, QCL-TypeD with the same periodic CSI-RS resource.

For a CSI-RS resource of NZP-CSI-RS-ResourceSet configured without a higher layer parameter trs-Info and without a higher layer parameter repetition, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a SS/PBCH block, or
QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or
when QCL-TypeD is not applicable, QCL-TypeB with a CSI-RS resource in configured NZP-CSI-RS-ResourceSet including a higher layer parameter trs-Info.

For a CSI-RS resource of configured NZP-CSI-RS-ResourceSet including a higher layer parameter repetition, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or
QCL-TypeC with a SS/PBCH block, and if applicable, QCL-TypeD with the same SS/PBCH block.

For a DMRS of a PDCCH, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or
QCL-TypeA with a CSI-RS resource of NZP-CSI-RS-ResourceSet configured without a higher layer parameter trs-Info and without a higher layer parameter repetition, and if applicable, QCL-TypeD with the same CSI-RS resource.

For a DMRS of a PDSCH, UE may expect a TCI state to indicate one of the following QCL type(s).
QCL-TypeA with a CSI-RS resource of configured NZP-CSI-RS-ResourceSet including a higher layer parameter trs-Info, and if applicable, QCL-TypeD with the same CSI-RS resource, or
QCL-TypeA with a CSI-RS resource of configured NZP-CSI-RS-ResourceSet including a higher layer parameter trs-Info, and if applicable, QCL-TypeD with a CSI-RS resource in configured NZP-CSI-RS-ResourceSet including a higher layer parameter repetition, or
QCL-TypeA with a CSI-RS resource of NZP-CSI-RS-ResourceSet configured without a higher layer parameter trs-Info and without a higher layer parameter repetition, and if applicable, QCL-TypeD with the same CSI-RS resource.

### Artificial Intelligence (AI) Operation

With the technological advancement of artificial intelligence/machine learning (AI/ML), node(s) and UE(s) in a wireless communication network are becoming more intelligent/advanced. In particular, due to the intelligence of networks/base stations, it is expected that it will be possible to rapidly optimize and derive/apply various network/base station decision parameter values (e.g., transmission/reception power of each base station, transmission power of each UE, precoder/beam of base station/UE, time/frequency resource allocation for each UE, duplex method of each base station, etc.) according to various environmental parameters (e.g., distribution/location of base stations, distribution/location/material of buildings/furniture, etc., location/movement direction/speed of UEs, climate information, etc.). Following this trend, many standardization organizations (e.g., 3GPP, O-RAN) are considering introduction, and studies on this are also actively underway.

AI-related descriptions and operations described below may be applied in combination with methods proposed in the present disclosure described later, or may be supplemented to clarify technical characteristics of methods proposed in the present disclosure.

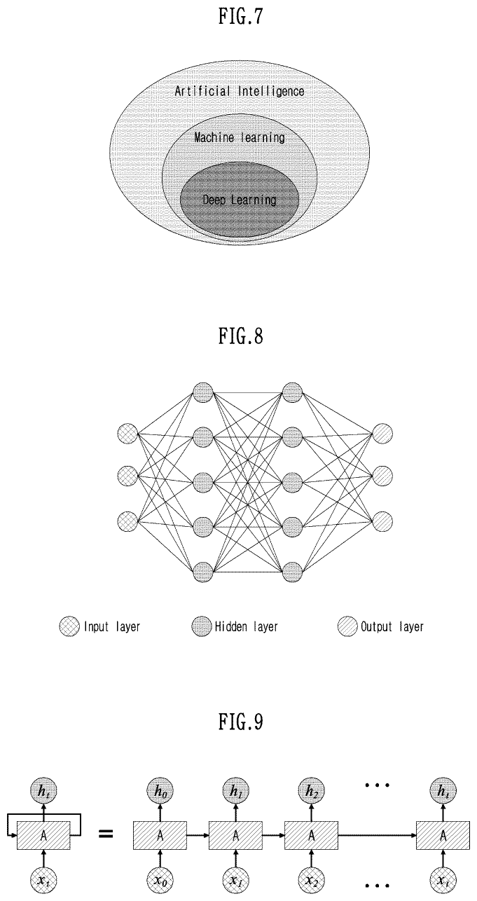

FIG. 7 illustrates a classification of artificial intelligence.

Referring to FIG. 7, artificial intelligence (AI) corresponds to all automation in which machines can replace work that should be done by humans.

Machine Learning (ML) refers to a technology in which machines learn patterns for decision-making from data on their own without explicitly programming rules.

Deep Learning is an artificial neural network-based model that allows a machine to perform feature extraction and decision from unstructured data at once. The algorithm relies on a multi-layer network of interconnected nodes for feature extraction and transformation, inspired by the biological nervous system, or Neural Network. Common deep learning network architectures include deep neural networks (DNNs), recurrent neural networks (RNNs), and convolutional neural networks (CNNs).

AI (or referred to as AI/ML) can be narrowly referred to as artificial intelligence based on deep learning, but is not limited to this in the present disclosure. That is, in the present disclosure, AI (or AI/ML) may collectively refer to automation technologies applied to intelligent machines (e.g., UE, RAN, network nodes, etc.) that can perform tasks like humans.

AI (or AI/ML) can be classified according to various criteria as follows.

### 1. Offline/Online Learning

### a) Offline Learning

Offline learning follows a sequential procedure of database collection, learning, and prediction. In other words, collection and learning can be performed offline, and the completed program can be installed in the field and used for prediction work. For offline learning, a system does not learn gradually, and learning is performed by using all available collected data and applied to a system without further learning. If learning on new data is required, learning may be started again by using the entire new data.

### b) Online Learning

It refers to a method of gradually improving performance through incremental additional learning with data generated in real time by utilizing a fact that data which may be utilized for recent learning is continuously generated through the Internet. Learning is performed in real time in a (bundle) unit of specific data collected online, allowing the system to quickly adapt to changing data changing.

Only online learning may be used to build an AI system and learning may be performed only with data generated in real time, or after offline learning is performed by using a predetermined data set, additional learning may be performed by using real-time data generated additionally (online+offline learning).

### 2. Classification According to AI/ML Framework Concept

### a) Centralized Learning

In centralized learning, training data collected from a plurality of different nodes is reported to a centralized node, all data resources/storage/learning (e.g., supervised learning, unsupervised learning, reinforcement learning, etc.) are performed in one centralized node.

### b) Federated Learning

Federated learning is a collective model built on data that exists across distributed data owners. Instead of collecting data into a model, AI/ML models are imported into a data source, allowing local nodes/individual devices to collect data and train their own copies of the model, eliminating the need to report the source data to a central node. In federated learning, the parameters/weights of an AI/ML model can be sent back to the centralized node to support general model training. Federated learning has advantages in terms of increased computation speed and information security. In other words, the process of uploading personal data to the central server is unnecessary, preventing leakage and misuse of personal information.

### c) Distributed Learning

Distributed learning refers to the concept in which machine learning processes are scaled and distributed across a cluster of nodes. Training models are split and shared across multiple nodes operating simultaneously to speed up model training.

### 3. Classification According to Learning Method

### a) Supervised Learning

Supervised learning is a machine learning task that aims to learn a mapping function from input to output, given a labeled data set. The input data is called training data and has known labels or results. An example of supervised learning is as follows.
Regression: Linear Regression, Logistic Regression
Instance-based Algorithms: k-Nearest Neighbor (KNN)
Decision Tree Algorithms: Classification and Regression Tree (CART)
Support Vector Machines (SVM)
Bayesian Algorithms: Naive Bayes
Ensemble Algorithms: Extreme Gradient Boosting, Bagging: Random Forest

Supervised learning can be further grouped into regression and classification problems, where classification is predicting a label and regression is predicting a quantity.

### b) Unsupervised Learning

Unsupervised learning is a machine learning task that aims to learn features that describe hidden structures in unlabeled data. The input data is not labeled and there are no known results. Some examples of unsupervised learning include K-means clustering, Principal Component Analysis (PCA), nonlinear Independent Component Analysis (ICA), and Long-Short-Term Memory (LSTM).

### c) Reinforcement Learning (RL)

In reinforcement learning (RL), the agent aims to optimize long-term goals by interacting with the environment based on a trial and error process, and is goal-oriented learning based on interaction with the environment. An example of the RL algorithm is as follows.
Q-learning
Multi-armed bandit learning
Deep Q Network
State-Action-Reward-State-Action (SARSA)
Temporal Difference Learning
Actor-critic reinforcement learning
Deep deterministic policy gradient (DDPG)
Monte-Carlo tree search

Additionally, reinforcement learning can be grouped into model-based reinforcement learning and model-free reinforcement learning as follows.
Model-based reinforcement learning: refers to RL algorithm that uses a prediction model. Using a model of the various dynamic states of the environment and which states lead to rewards, the probabilities of transitions between states are obtained.
Model-free reinforcement learning: refers to RL algorithm based on value or policy that achieves the maximum future reward. Multi-agent environments/states are computationally less complex and do not require an accurate representation of the environment.

Additionally, RL algorithm can also be classified into value-based RL vs. policy-based RL, policy-based RL vs. non-policy RL, etc.

Hereinafter, representative models of deep learning will be exemplified.

FIG. 8 illustrates a feed-forward neural network.

A feed-forward neural network (FFNN) is composed of an input layer, a hidden layer, and an output layer.

In FFNN, information is transmitted only from the input layer to the output layer, and if there is a hidden layer, it passes through it.

Potential parameters that may be considered in relation to FNNN are as follows.
Category 1: Number of neurons in each layer, number of hidden layers, activation function of each layer/neuron
Category 2: Weight and bias of each layer/neuron
Category 3: loss function, optimizer

As an example, Category 1, Category 2, and Category 3 may be considered in terms of training, and Category 1 and Category 2 may be considered in terms of inference.

FIG. 9 illustrates a recurrent neural network.

A recurrent neural network (RNN) is a type of artificial neural network in which hidden nodes are connected to directed edges to form a directed cycle. This model is suitable for processing data that appears sequentially, such as voice and text.

In FIG. 9, A represents a neural network, xt represents an input value, and ht represents an output value. Here, ht may refer to a state value representing the current state based on time, and ht−1 may represent a previous state value.

One type of RNN is LSTM (Long Short-Term Memory), which has a structure that adds a cell-state to the hidden state of the RNN. LSTM can erase unnecessary memories by adding an input gate, forgetting gate, and output gate to the RNN cell (memory cell of the hidden layer). LSTM adds cell state compared to RNN.

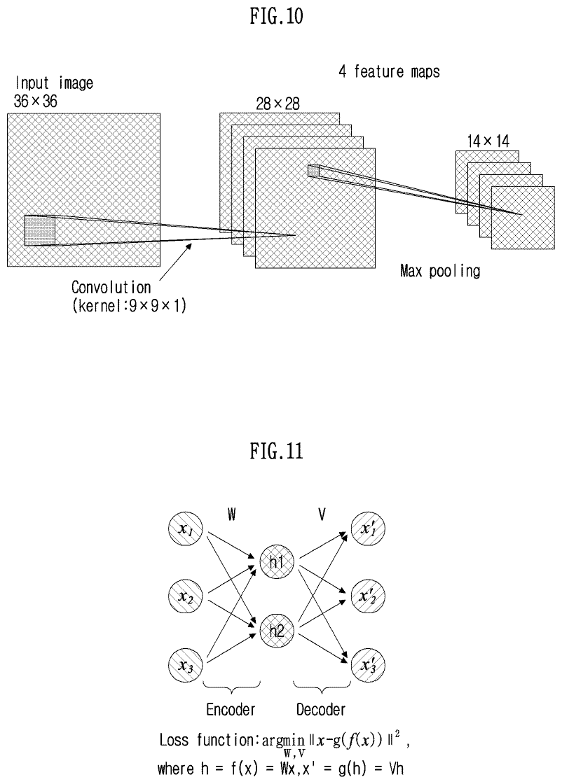

FIG. 10 illustrates a convolutional neural network.

Convolutional neural network (CNN) is used for two purposes: reducing model complexity and extracting good features by applying convolution operations commonly used in the image processing or image processing fields.
Kernel or filter: refers to a unit/structure that applies weight to input of a specific range/unit. The kernel (or filter) can be changed through learning.
Stride: refers to the movement range of moving the kernel within the input.
Feature map: refers to the result of applying the kernel to input. Several feature maps can be extracted to ensure robustness to distortion, change, etc.
Padding: refers to a value added to adjust the size of the feature map.
Pooling: refers to an operation (e.g., max pooling, average pooling) to reduce the size of the feature map by downsampling the feature map.

Potential parameters that may be considered in relation to CNN are as follows.
Category 1: Structural information of each layer (e.g., number of hidden layers, padding presence/value, pooling presence/type, etc.)
Category 2: Size/weight of kernel, activation function/stride of each layer/kernel, bias of each layer/kernel
Category 3: loss function, optimizer

As an example, Category 1, Category 2, and Category 3 may be considered in terms of training, and Category 1 and Category 2 may be considered in terms of inference.

FIG. 11 illustrates an auto encoder.

Auto encoder refers to a neural network that receives a feature vector x (x1, x2, x3, . . . ) as input and outputs the same or similar vector x′(x′₁, x′₂, x′₃, . . . )′.

Auto encoder has the same characteristics as the input node and output node. Since the auto encoder reconstructs the input, the output can be referred to as reconstruction. Additionally, auto encoder is a type of unsupervised learning.

The loss function of the auto encoder illustrated in FIG. 11 is calculated based on the difference between input and output, and based on this, the degree of input loss is identified and an optimization process is performed in the auto encoder to minimize the loss.

Hereinafter, for a more specific explanation of AI (or AI/ML), terms can be defined as follows.

Data collection: Data collected from the network nodes, management entity or UE, as a basis for AI model training, data analytics and inference.
AI Model: A data driven algorithm by applying AI techniques that generates a set of outputs consisting of predicted information and/or decision parameters, based on a set of inputs.
AI/ML Training: An online or offline process to train an AI model by learning features and patterns that best present data and get the trained AI/ML model for inference.
AI/ML Inference: A process of using a trained AI/ML model to make a prediction or guide the decision based on collected data and AI/ML model.

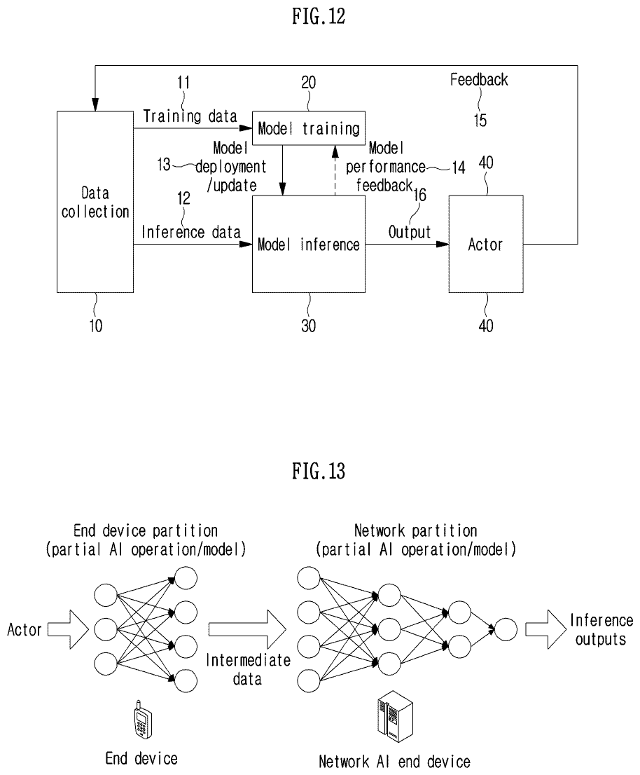

FIG. 12 illustrates a functional framework for an AI operation.

Referring to FIG. 12, the data collection function (10) is a function that collects input data and provides processed input data to the model training function (20) and the model inference function (30).

Examples of input data may include measurements from UEs or different network entities, feedback from Actor, output from an AI model.

The Data Collection function (10) performs data preparation based on input data and provides input data processed through data preparation. Here, the Data Collection function (10) does not perform specific data preparation (e.g., data pre-processing and cleaning, formatting and transformation) for each AI algorithm, and data preparation common to AI algorithms can be performed.

After performing the data preparation process, the Model Training function (10) provides Training Data (11) to the Model Training function (20) and provides Inference Data (12) to the Model Inference function (30). Here, Training Data (11) is data required as input for the AI Model Training function (20). Inference Data (12) is data required as input for the AI Model Inference function (30).

The Data Collection function (10) may be performed by a single entity (e.g., UE, RAN node, network node, etc.), but may also be performed by a plurality of entities. In this case, Training Data (11) and Inference Data (12) can be provided from a plurality of entities to the Model Training function (20) and the Model Inference function (30), respectively.

Model Training function (20) is a function that performs the AI model training, validation, and testing which may generate model performance metrics as part of the model testing procedure. The Model Training function (20) is also responsible for data preparation (e.g., data pre-processing and cleaning, formatting, and transformation) based on Training Data (11) delivered by a Data Collection function (10), if required.

Here, Model Deployment/Update (13) is used to initially deploy a trained, validated, and tested AI model to the Model Inference function (30) or to deliver an updated model to the Model Inference function (30).

Model Inference function (30) is a function that provides AI model inference output (16) (e.g., predictions or decisions). Model Inference function (30) may provide Model Performance Feedback (14) to Model Training function (20) when applicable. The Model Inference function (30) is also responsible for data preparation (e.g., data pre-processing and cleaning, formatting, and transformation) based on Inference Data (12) delivered by a Data Collection function (10), if required.

Here, Output (16) refers to the inference output of the AI model produced by a Model Inference function (30), and details of inference output may be use case specific.

Model Performance Feedback (14) may be used for monitoring the performance of the AI model, when available, and this feedback may be omitted.

Actor function (40) is a function that receives the Output (16) from the Model Inference function (30) and triggers or performs corresponding actions. The Actor function (40) may trigger actions directed to other entities (e.g., one or more UEs, one or more RAN nodes, one or more network nodes, etc) or to itself.

Feedback (15) may be used to derive Training data (11), Inference data (12) or to monitor the performance of the AI Model and its impact to the network, etc.

Meanwhile, the definitions of training/validation/test in the data set used in AI/ML can be divided as follows.
Training data: refers to a data set for learning a model.
Validation data: This refers to a data set for verifying a model for which learning has already been completed. In other words, it usually refers to a data set used to prevent over-fitting of the training data set.

It also refers to a data set for selecting the best among various models learned during the learning process. Therefore, it can also be considered as a type of learning.
Test data: refers to a data set for final evaluation. This data is unrelated to learning.

In the case of the data set, if the training set is generally divided, within the entire training set, training data and validation data can be divided into 8:2 or 7:3, and if testing is included, 6:2:2 (training: validation: test) can be used.

Depending on the capability of the AI/ML function between a base station and a UE, a cooperation level can be defined as follows, and modifications can be made by combining the following multiple levels or separating any one level.
Cat 0a) No collaboration framework: AI/ML algorithm is purely implementation-based and do not require any air interface changes.
Cat 0b) This level corresponds to a framework without cooperation but with a modified air interface tailored to efficient implementation-based AI/ML algorithm.
Cat 1) This involves inter-node support to improve the AI/ML algorithm of each node. This applies if a UE receives support from a gNB (for training, adaptation, etc.) and vice versa. At this level, model exchange between network nodes is not required.
Cat 2) Joint ML tasks between a UE and a gNB may be performed. This level requires AI/ML model command and an exchange between network nodes.

The functions previously illustrated in FIG. 12 may be implemented in a RAN node (e.g., base station, TRP, base station central unit (CU), etc.), a network node, a network operator's operation administration maintenance (OAM), or a UE.

Alternatively, the function illustrated in FIG. 12 may be implemented through cooperation of two or more entities among a RAN, a network node, an OAM of network operator, or a UE. For example, one entity may perform some of the functions of FIG. 12 and other entities may perform the remaining functions. As such, as some of the functions illustrated in FIG. 12 are performed by a single entity (e.g., UE, RAN node, network node, etc.), transmission/provision of data/information between each function may be omitted. For example, if the Model Training function (20) and the Model Inference function (30) are performed by the same entity, the delivery/provision of Model Deployment/Update (13) and Model Performance Feedback (14) can be omitted.

Alternatively, any one of the functions illustrated in FIG. 12 may be performed through collaboration between two or more entities among a RAN, a network node, an OAM of a network operator, or a UE. This can be referred to as a split AI operation.

FIG. 13 is a diagram illustrating split AI inference.

FIG. 13 illustrates a case in which, among split AI operations, the Model Inference function is performed in cooperation with an end device such as a UE and a network AI/ML endpoint.

In addition to the Model Inference function, the Model Training function, the Actor, and the Data Collection function are respectively split into multiple parts depending on the current task and environment, and can be performed by multiple entities collaborating.

For example, computation-intensive and energy-intensive parts may be performed at a network endpoint, while parts sensitive to personal information and delay-sensitive parts may be performed at an end device. In this case, an end device can execute a task/model from input data to a specific part/layer and then transmit intermediate data to a network endpoint. A network endpoint executes the remaining parts/layers and provides inference outputs to one or more devices that perform an action/task.

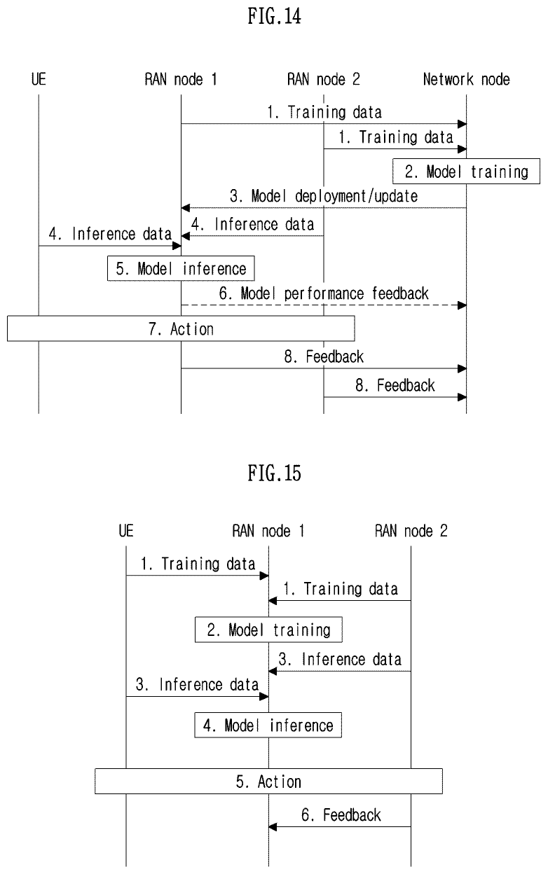

FIG. 14 illustrates an application of a functional framework in a wireless communication system.

FIG. 14 illustrates a case where the AI Model Training function is performed by a network node (e.g., core network node, network operator's OAM, etc.) and the AI Model Inference function is performed by a RAN node (e.g., base station, TRP, CU of base station, etc.).
Step 1: RAN Node 1 and RAN Node 2 transmit input data (i.e., Training data) for AI Model Training to the network node. Here, RAN Node 1 and RAN Node 2 may transmit the data collected from the UE (e.g., UE measurements related to RSRP, RSRQ, SINR of the serving cell and neighboring cells, UE location, speed, etc.) to the network node.
Step 2: The network node trains the AI Model using the received training data.
Step 3: The network node distributes/updates the AI Model to RAN Node 1 and/or RAN Node 2. RAN Node 1 (and/or RAN Node 2) may continue to perform model training based on the received AI Model.

For convenience of explanation, it is assumed that the AI Model has been distributed/updated only to RAN Node 1.
Step 4: RAN Node 1 receives input data (i.e., Inference data) for AI Model Inference from the UE and RAN Node 2.
Step 5: RAN Node 1 performs AI Model Inference using the received Inference data to generate output data (e.g., prediction or decision).
Step 6: If applicable, RAN Node 1 may send model performance feedback to the network node.
Step 7: RAN Node 1, RAN Node 2, and UE (or ‘RAN Node 1 and UE’, or ‘RAN Node 1 and RAN Node 2’) perform an action based on the output data. For example, in the case of load balancing operation, the UE may move from RAN node 1 to RAN node 2.
Step 8: RAN Node 1 and RAN Node 2 transmit feedback information to the network node.

FIG. 15 illustrates an application of a functional framework in a wireless communication system.

FIG. 15 illustrates a case where both the AI Model Training function and the AI Model Inference function are performed by a RAN node (e.g., base station, TRP, CU of the base station, etc.).
Step 1: The UE and RAN Node 2 transmit input data (i.e., Training data) for AI Model Training to RAN Node 1.
Step 2: RAN Node 1 trains the AI Model using the received training data.
Step 3: RAN Node 1 receives input data (i.e., Inference data) for AI Model Inference from the UE and RAN Node 2.
Step 4: RAN Node 1 performs AI Model Inference using the received Inference data to generate output data (e.g., prediction or decision).
Step 5: RAN Node 1, RAN Node 2, and the UE (or ‘RAN Node 1 and UE’, or ‘RAN Node 1 and RAN Node 2’) perform an action based on the output data. For example, in the case of load balancing operation, the UE may move from RAN node 1 to RAN node 2.
Step 6: RAN node 2 transmits feedback information to RAN node 1.

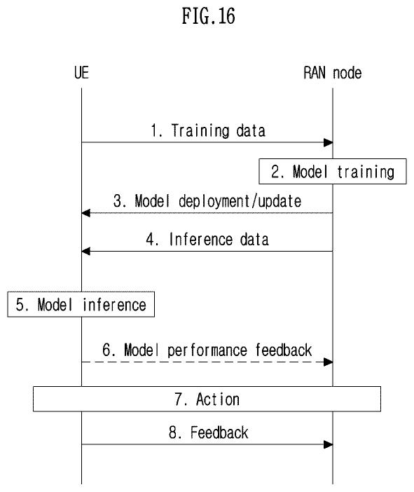

FIG. 16 illustrates an application of a functional framework in a wireless communication system.

FIG. 16 illustrates a case where the AI Model Training function is performed by a RAN node (e.g., base station, TRP, CU of the base station, etc.), and the AI Model Inference function is performed by the UE.
Step 1: The UE transmits input data (i.e., Training data) for AI Model Training to the RAN node. Here, the RAN node may collect data (e.g., measurements of the UE related to RSRP, RSRQ, SINR of the serving cell and neighboring cells, location of the UE, speed, etc.) from various UEs and/or from other RAN nodes.
Step 2: The RAN node trains the AI Model using the received training data.
Step 3: The RAN node distributes/updates the AI Model to the UE. The UE may continue to perform model training based on the received AI Model.
Step 4: The UE receives input data (i.e., Inference data) for AI Model Inference from the RAN node (and/or from other UEs).
Step 5: The UE performs AI Model Inference using the received Inference data to generate output data (e.g., prediction or decision).
Step 6: If applicable, the UE may transmit model performance feedback to the RAN node.
Step 7: The UE and the RAN node perform an action based on output data.
Step 8: The UE transmits feedback information to the RAN node.

### Enhanced Codebook-Based CSI

CSI feedback may be improved based on a NN (e.g., DNN) structure as described above. It may be called AI/ML-enhanced CSI feedback. A NN structure described above may be an example for performing AI/ML-enhanced CSI feedback, and a type/an example, etc. of a NN structure do not limit a scope of the present disclosure. In other words, a term of NN in the present disclosure may be used as an example of an AI/ML model, and an AI/ML model refers to a model based on AI and/or ML technology. In the present disclosure, it is mainly described by using a term of AI/ML model, but the AI/ML-enhanced CSI feedback of the present disclosure may also be performed based on another NN structure and/or AI/ML algorithm.

AI/ML-enhanced CSI feedback based on various NN and/or AI/ML algorithms may be applied to reduce CSI feedback overhead between a base station and a terminal or to increase the accuracy of CSI. In order to minimize an impact of applying an AI/ML algorithm while making the most of a CSI feedback framework defined in the existing wireless communication system, the existing codebook-based precoding matrix report may be used. The present disclosure describes various examples of AI/ML-enhanced CSI feedback that may be applied to codebook-based precoding matrix report.

A codebook may correspond to a set of precoding matrices defined/shared in advance between a base station and a terminal. At least one codebook may be defined/shared in advance, and information indicating at least one element (or codeword) of them (e.g., a PMI) may be reported from a terminal to a base station. The existing codebook includes a limited number of quantized precoding matrices, and a PMI may indicate a precoding matrix that is closest to a channel characteristic estimated by a terminal among them. In other words, a precoding matrix corresponding to a reported PMI is close to an estimated channel characteristic, but has a limitation that it is limited to predefined quantized elements.

When certain information is defined between a terminal and a base station in the present disclosure, it may mean that a terminal and a base station know corresponding information without separate signaling between a terminal and a base station; when it is configured between a terminal and a base station, it may mean that corresponding information is transmitted/received through higher layer (e.g., RRC) signaling between a terminal and a base station; and when it is indicated between a terminal and a base station, it may mean that corresponding information is transmitted/received through lower layer (e.g., L1 (e.g., DCI/UCI), L2 (e.g., MAC-CE)) signaling.

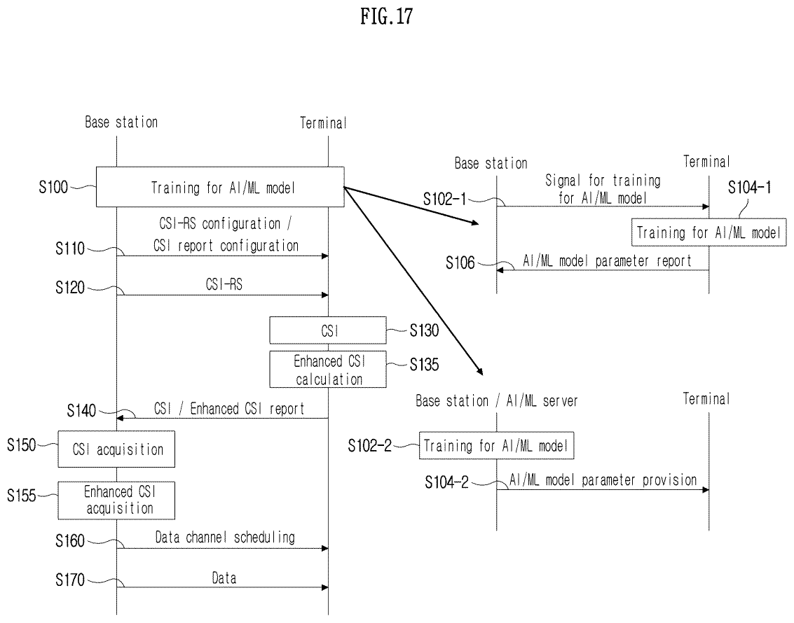

FIG. 17 is a diagram illustratively showing an operation of a base station and a terminal for AI/ML-enhanced CSI feedback to which the present disclosure may be applied.

Enhanced codebook-based CSI in the present disclosure may correspond to a method for reporting more precise CSI based on a precoding matrix that is closer to an estimated channel characteristic beyond a limitation of a precoding matrix included in the existing codebook while using the existing codebook-based precoding matrix report.

S100 in FIG. 17 may include a training (or learning of a NN parameter) and sharing operation of an AI/ML model (e.g., NN) for obtaining AI/ML-enhanced CSI in a base station and a terminal, respectively. Training for an AI/ML model (or NN) may be performed in a terminal, or may be performed on a network side (e.g., a base station and/or an AI/ML server).

For example, a base station may transmit a signal for a terminal to train NN (e.g., known data/sequence, etc.) to a terminal in S102-1, a terminal may perform training for an AI/ML model (or parameter learning for an AI/ML model) in S104-1, and a terminal may report a training result or a parameter for a learned AI/ML model to a base station in S106-1. A parameter for an AI/ML model may be reported to a base station along with CSI report of S140.

Additionally or alternatively, training for an AI/ML model (or parameter learning for an AI/ML model) may be performed by a base station/an AI/ML server in S102-2, and a training result for an AI/ML model or a parameter for a learned AI/ML model may be provided to a terminal in S104-2. Accordingly, a terminal may infer an AI/ML model.

In examples described above, reporting/providing a parameter for an AI/ML model may include transferring or delivering a trained AI/ML model. For example, AI/ML model delivery means that an AI/ML model is delivered from one entity to another entity in any manner, and an entity may correspond to a network node/a function (e.g., gNB, a Location Management Function (LMF), etc.), a terminal proprietary server, etc. AI/ML model transfer corresponds to the delivery of an AI/ML model through an air interface, and a parameter of a model structure known to a receiving end may be delivered or a new model may be delivered with a parameter. Delivery may include part or all of a model.

Before training for an AI/ML model (S100), capability information of a terminal related to an AI/ML model may be reported to a base station. Additionally or alternatively, terminal capability information may be reported to a base station together with CSI report of S140. For example, based on capability information of a terminal, etc., AI/ML model related configuration information, signal related configuration information for AI/ML model training, etc. may be configured/indicated to a terminal before S100.

Si 10 to S140 correspond to an operation in which a terminal calculates/obtains CSI based on CSI-RS transmitted by a base station and a terminal reports it to a base station. A CSI-RS configuration of S110 may include configuration information about a resource for CSI-RS transmission, a transmission method, etc., and a CSI report configuration may include configuration information about report quantity, a report method, etc. that must be reported by a terminal. In S120, a base station may transmit a CSI-RS to a terminal and a terminal may receive it. In S130, a terminal may calculate/obtain CSI (e.g., CRI, RI, PMI, CQI, L1, etc.) based on a received CSI-RS. In S140, a terminal may report calculated/obtained CSI to a base station. In S15, a base station may obtain CSI.

In S135, a terminal may calculate/obtain AI/ML-enhanced CSI based on calculated CSI and AI/ML model, in addition to CSI calculated based on a CSI-RS in S130. Enhanced CSI may be reported to a base station in S140 together with or separately from CSI. Enhanced CSI may be obtained in S155. For example, in S155, a base station may obtain enhanced CSI from CSI from a terminal obtained in S150 based on a parameter for an AI/ML model (or an AI/ML model to which a parameter for an AI/ML model is applied) reported from a terminal or provided to a terminal in S100. Additionally or alternatively, a base station may obtain information about a channel estimated by a terminal (e.g., a precoding matrix assumed by a terminal for calculating an enhanced CQI) based on a parameter for an AI/ML model for enhanced CSI (e.g., an enhanced CQI) from a terminal obtained in S155 as CSI enhanced by a base station.

In S160 and S170, a base station may schedule a data channel (e.g., a PDSCH) based on CSI obtained/CSI enhanced from a terminal (e.g., transmit DCI including scheduling information through a PDCCH) and transmit data to a terminal through a data channel based on scheduling information. A base station just refers to CSI/enhanced CSI from a terminal in downlink data scheduling, but may not necessarily reflect it.

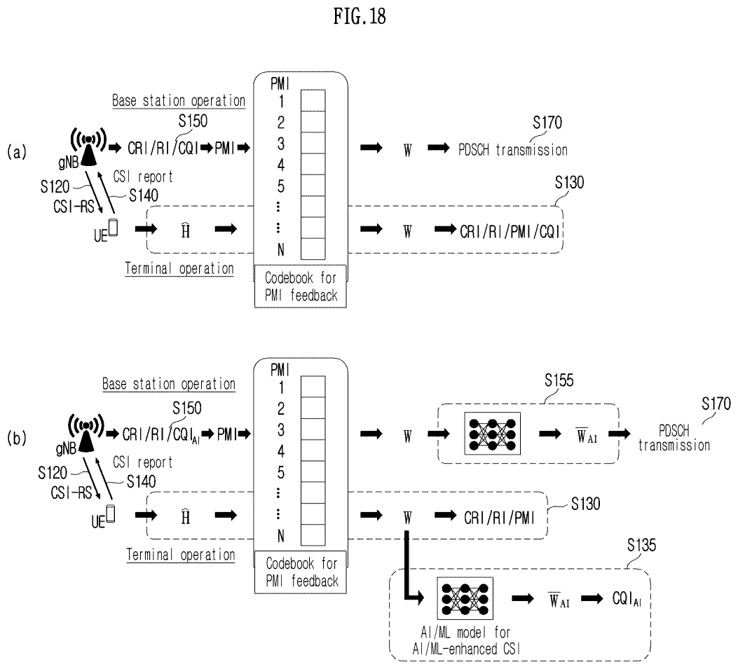

FIG. 18 is a diagram for describing codebook-based and enhanced codebook-based CSI feedback to which the present disclosure may be applied.

A diagram sign shown in FIG. 18 shows a corresponding step in an example of FIG. 17.

FIG. 18(a) shows an example of an operation for performing CSI feedback based on a codebook for a precoding matrix shared between a base station and a terminal in an existing wireless communication system and transmitting a data channel by referring to CSI.

A terminal may receive a CSI-RS (S120) and estimate channel Ĥ through it. A terminal may select/calculate a suitable precoding matrix W within a configured codebook based on an estimated channel (S130). A terminal may report CSI such as CRI/RI/CQI, etc. to a base station, including a PMI corresponding to a selected/determined precoding matrix (S140). A codebook may include a codebook defined in an existing wireless communication system (e.g., at least one codebook defined in various ways based on Type I/Type II, single-panel/multi-panel, port selection, the number of CSI report layers, etc.) and/or a codebook to be defined in a future wireless communication system.

Once a precoding matrix is selected/determined, a CQI based on a corresponding precoding matrix may be calculated. For example, when report of a CQI index is configured, in a CSI reference resource, in order to derive a CQI index, a terminal may apply various assumptions including an assumption on a PDSCH transmission technique considering that PDSCH transmission is performed with up to 8 transmission layers. As given in Equation below, for CQI calculation, a terminal may assume that a DPSCH signal on an antenna port [1000, . . . , 1000+v−1] for v layers is a signal equivalent to a corresponding symbol transmitted on an antenna port [3000, . . . , 3000+P−1]. In Equation below, W(i) may correspond to a precoding matrix.

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ] \qquad [ Equation 3 ]$$

Here, x(i)=[x⁽⁰⁾(i) . . . x^{(v-1)}(i)]^{T} is a vector of a PDSCH symbol from layer mapping, and P∈[1, 2, 4, 8, 12, 16, 24, 32] may correspond to the number of CSI-RS ports. If only one CSI-RS port is configured, W(i) is 1. When a CSI report quantity which is a higher layer parameter in a CSI report configuration is configured as ‘cri-RI-PMI-CQI’ or ‘cri-RI-LI-PMI-CQI’ including CQI report, W(i) may be a precoding matrix corresponding to a reported PMI applicable to x(i). When a CSI report quantity which is a higher layer parameter in a CSI report configuration is configured as ‘cri-RI-CQI’ including CQI report, W(i) may be determined according to a procedure according to whether to configure a PMI port indication. When a CSI report quantity which is a higher layer parameter in a CSI report configuration is configured as ‘cri-RI-il-CQI’ including CQI report, W(i) may be a precoding matrix corresponding to il reported in a procedure according to a reported codebook type and PMI format indicator. A PDSCH signal transmitted on an antenna port [3000, . . . , 3000+P−1] may have a ratio of EPRE to CSI-RS EPRE equal to a ratio given as a predetermined value. When a CSI report quantity which is a higher layer parameter in a CSI report configuration is configured as ‘cri-RI-PMI-CQI’ or ‘cri-RI-LI-PMI-CQI’ including CQI report, a corresponding CSI-RS resource set for channel measurement may be configured as two resource groups and N resource pairs, a reported CRI may correspond to one entry of the N resource pairs and a reported rank combination may be {v₁,v₂}.

FIG. 18(b) shows an example of an operation for performing AI/ML-enhanced CSI feedback based on an AI/ML model and transmitting a data channel by referring to AI/ML-enhanced CSI. Since AI/ML-enhanced CSI is based on a precoding matrix not included in a codebook, it may be referred to as non-codebook-based CSI, but in the present disclosure, in order to express a feature of deriving enhanced CSI by applying an AI/ML model based on the existing codebook-based CSI, it is also referred to as enhanced codebook-based CSI.

Similar to an example of FIG. 18(a), an example of FIG. 18(b) may also perform CSI-RS reception (S120), channel estimation, CSI calculation including a PMI (S130) and CSI report (S140). In addition, a terminal may calculate W̅_{AI} which corresponds to a precoding matrix more suitable for a channel estimated by a terminal based on precoding matrix W selected in a codebook and a trained AI/ML model. In addition, CQI_{AI} corresponding to AI/ML-enhanced CSI may be calculated based on W̅_{AI} (e.g., according to a precoding matrix-based CQI calculation operation described by referring to Equation 3 described above). CQI_{AI} may be reported to a base station in addition to or in place of an existing CQI (i.e., a CQI calculated based on a codebook-based precoding matrix).

A base station may obtain W̅_{AI} that is assumed by a terminal when calculating CQI_{AI}, based on a report value for a parameter for a trained AI/ML model and a PMI reported from a terminal. A base station may perform scheduling for a data channel (e.g., specifying a MCS for a data channel) based on CQI_{AI} and transmit data through a data channel based on W̅_{AI}.

In examples described by referring to FIGS. 17 and 18, an operation of a base station and a terminal just describes an operation mainly assumed in the present disclosure, and it is not intended to limit a scope of the present disclosure. In particular, a specific term described in an example of FIGS. 17 and 18 does not limit a specific function/operation. Accordingly, a function/an operation/a method in the above-described examples is not limited by a specific term, and even when it is referred to by another term, it may also be included in a scope of the present disclosure. In addition, a scope of the present disclosure may also include changing the order of some operations, adding some operations or omitting some operations in the above-described examples.

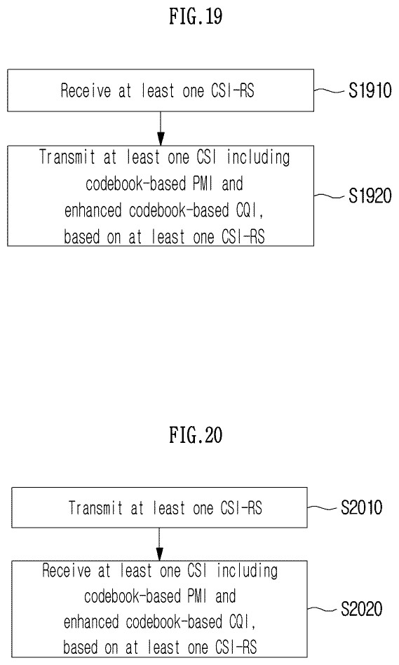

FIG. 19 is a diagram for describing an example of an enhanced codebook-based CSI transmission method of a terminal according to the present disclosure.

In S1910, a terminal may receive at least one CSI-RS from a network. CSI-RS transmission may be performed based on a CSI-RS configuration and/or a CSI report configuration preconfigured for a terminal. Based on a CSI report configuration, information on a report quantity to be included in at least one CSI report may be configured/indicated to a terminal.

In S1920, a terminal may transmit at least one CSI including a codebook-based PMI and an enhanced codebook-based CQI based on at least one CSI-RS to a network.

CSI based on a CSI-RS such as a PMI, a CQI, etc. may correspond to CSI showing a characteristic of a channel estimated by a terminal based on a CSI-RS.

A codebook-based PMI corresponds to a first precoding matrix, and a first precoding matrix may be included in a set of precoding matrices defined by at least one predetermined codebook.

An enhanced codebook-based CQI may be calculated based on a second precoding matrix. A second precoding matrix may be determined based on a first precoding matrix and at least one AI/ML model-related information.

For example, it may be a precoding matrix that is not included in a set of precoding matrices associated with a first precoding matrix (i.e., at least one predetermined codebook-based precoding matrix(s)). For example, a second precoding matrix may be a precoding matrix that corresponds to a relatively finer granularity, corresponds to a channel state in a relatively more future time point and/or is relatively closer to a channel estimated by a terminal, compared to a first precoding matrix. Additionally or alternatively, a second precoding matrix may be derived based on an AI/ML model trained based on a channel state estimated by a terminal or may be information about an estimated channel itself and/or may be information showing a similarity to an estimated channel.

AI/ML model-related information is shared in advance between a network and a terminal, and may include AI/ML model-related information for a terminal and/or a network. For example, AI/ML model-related information may include configuration information for an AI/ML model, a parameter for an AI/ML model, data used to derive configuration information/parameter for an AI/ML model and/or type information for an AI/ML model.

Information included in one CSI report may be at least one of a first PMI indicating a first precoding matrix, a first CQI based on a first precoding matrix or a second CQI based on a second precoding matrix. Additionally or alternatively, a first PMI may be included in first CSI report and a second CQI may be included in second CSI report. For example, a second CQI may be defined as a differential value based on a first CQI. A differential value may correspond to a differential value for a CQI index, a SNR, a SINR, a MCS, etc. For example, a frequency band size on which a first CQI and a second CQI are based may be configured/indicated differently. For example, among the CSI reports, a second CQI may be reported to a network together with a terminal's AI/ML model-related information. For example, information indicating whether it includes at least one of a first CQI or a second CQI may be included in CSI report (e.g., first CSI report).

Together with or separately from at least one CSI report, a terminal may transmit a request for updating AI/ML model-related information to a network. For example, when a second CQI value has a specific value or when a combination of a second CQI and another CSI information has a specific value, it may correspond to a request for updating an AI/ML model-related parameter. When AI/ML model-related parameter update is requested, a network may interpret it as a request for transmitting a new training signal. In response to a request for updating AI/ML model-related information, whether to report a second CQI may be configured by a network to a terminal.

FIG. 20 is a diagram for describing an example of an enhanced codebook-based CSI reception method of a base station according to the present disclosure.

In S2010, a base station may transmit at least one CSI-RS to a terminal.

In S2020, a base station may receive from a terminal at least one CSI including a codebook-based PMI and an enhanced codebook-based CQI based on at least one CSI-RS.

A base station may perform resource allocation, data channel scheduling, etc. for a corresponding terminal by referring to CSI including enhanced codebook-based CSI received from a terminal.

Since a specific description of enhanced codebook-based CQI and AI/ML model-related information in an example of FIG. 20 is the same as that in an example of FIG. 19, an overlapping description is omitted.

Hereinafter, specific examples of enhanced codebook-based CSI feedback according to the present disclosure are described. For example, a method in which a terminal selects a first precoding matrix based on a codebook shared between a base station and a terminal, a method in which a terminal derives a second precoding matrix based on a first precoding matrix and AI/ML model-related information, a method in which a terminal derives a second CQI based on a second precoding matrix and a method in which a terminal reports a PMI and a second CQI for a first precoding matrix to a base station are described.

A first precoding matrix corresponds to a codebook-based precoding matrix. For example, a codebook-based precoding matrix may be included in a set of precoding matrices defined by a codebook defined in an existing wireless communication system (e.g., at least one codebook defined in various ways based on Type I/Type II, single-panel/multi-panel, port selection, the number of CSI report layers, etc.) and/or a codebook to be defined in a future wireless communication system. A terminal may select a precoding matrix among a corresponding set of precoding matrices.

A second precoding matrix may refer to a precoding matrix that may be derived by a base station/a terminal based on a first precoding matrix and AI/ML model-related information. A second precoding matrix may correspond to a precoding matrix that is not shared between a base station and a terminal in a predetermined codebook manner.

A second CQI may refer to a CQI calculated based on a second precoding matrix according to a predetermined CQI calculation operation (e.g., a precoding matrix-based CQI calculation operation described by referring to Equation 3). For example, when a description related to Equation 3 described above is applied to an operation of the present disclosure for calculating a second CQI based on a second precoding matrix, W(i) in Equation 3 corresponds to a second precoding matrix that may be derived by a base station/a terminal based on a first precoding matrix (i.e., a codebook-based precoding matrix) and AI/ML model-related information.

A CSI report method itself in the present disclosure may be applied as it is to a CSI report method defined in an existing wireless communication system (e.g., CSI report timing, a report resource, a type of reported information, etc.) such as codebook-based PMI report and CQI report methods. In addition, the accuracy of a precoding matrix at a base station/a terminal may be improved by applying NN and/or AI/ML, improving system performance. Here, a base station/a terminal may share the same AI/ML model-related information (e.g., configuration information for an AI/ML model and/or a parameter for an AI/ML model), and based on this AI/ML model-related information and a first precoding matrix, a base station and a terminal may derive the same second precoding matrix. Accordingly, a terminal may not perform direct report on a second precoding matrix, and may use a current standard codebook-based PMI report method as it is.

### Embodiment 1

This embodiment relates to a method for deriving a second precoding matrix based on a first precoding matrix and AI/ML model-related information.

For example, a second precoding matrix having relatively denser density than a first precoding matrix may be derived.

In selecting/determining a precoding matrix, a sub-band size that may be configured for a terminal may be defined. According to a BWP size, a sub-band size may be configured/indicated as PRBs such as 4, 8, 16, 32, etc. For example, when a BWP size is 24-72 PRBs, a first precoding matrix may be configured to be reported in at least 4 PRB units. As such, when a first precoding matrix is configured to be reported in x PRB units, a second precoding matrix in y PRB units may be derived based on AI/ML model-related information (e.g., an AI/ML model configuration value and/or an AI/ML model parameter) learned in advance based on a first precoding matrix in x PRB units, a wireless channel characteristic, etc. through an AI/ML model. Here, y may be configured/indicated/defined as a value less than or equal to x.

Accordingly, the effect of indicating/using a precoding matrix having relatively finer granularity based on a relatively coarse codebook may be obtained. In addition, the effect of reducing a payload for a PMI may be obtained. For the same PMI payload, it may have the same effect as using a codebook with finer density.

Additionally or alternatively, a second precoding matrix suitable for a channel at a relatively future time point compared to a time point where a first precoding matrix is reported may be derived.

For example, for a mobile terminal, due to the time-variant characteristic of a wireless channel environment, the accuracy of reported CSI declines over time compared to a time point at which CSI is reported. Through an AI/ML model, based on a first precoding matrix reported at a specific time point and AI/ML model-related information learned in advance based on a wireless channel characteristic, etc. (e.g., an AI/ML model configuration value and/or an AI/ML model parameter), a second precoding matrix suitable for a channel at a future time point compared to a specific time point at which a first precoding matrix is reported may be derived.

Accordingly, it may have the effect of reporting precoding matrix-related information that is predicted to be suitable for a future time point.

Additionally or alternatively, if an optimal precoding matrix is referred to as Wₒₚₜ from a terminal's perspective derived by using singular value decomposition(SVD)/eigen value decomposition (EVD), etc., a precoding matrix that is as close as possible to Wₒₚₜ may be derived as a second precoding matrix.

A terminal may estimate a downlink channel based on a CSI-RS, etc. and use SVD/EVD, etc. to derive an optimal precoding matrix Wₒₚₜ from a terminal's perspective. Due to a limit to CSI feedback payload, a terminal may select a first precoding matrix most similar to WV from a set of precoding matrices in a codebook quantized to a certain level and report it to a base station. Through an AI/ML model, a second precoding matrix close to Wₒₚₜ (desirably, relatively closer to WV compared to a first precoding matrix) may be derived based on a first precoding matrix quantized to a certain level and AI/ML model-related information learned in advance based on a wireless channel characteristic, etc. (e.g., an AI/ML model configuration value and/or an AI/ML model parameter).

Accordingly, a base station may obtain a more sophisticated precoding matrix, increasing the strength of an intended signal and decreasing the strength of an interference signal to improve system performance.

Additionally or alternatively, AI/ML model training may be performed based on a channel measured by a terminal, deriving a PMI/a CQI. As such, a precoding matrix corresponding to a PMI derived through an AI/ML model may be determined as a second precoding matrix.

Additionally or alternatively, like a supervised learning method, input to an AI/ML model may be configured as a PMI and/or wireless channel information (e.g., channel delay, delay profile peak, etc.) and the output of an AI/ML model may be configured as an estimated channel and/or a similarity with an estimated channel. As suah, information about an estimated channel and/or information about a similarity with an estimated channel may be reported to a base station as a CQI based on a second precoding matrix. Alternatively, as such, information about an estimated channel and/or information about a similarity with an estimated channel may be reported to a base station as AI/ML-based CSI separate from a CQI based on a second precoding matrix.

### Embodiment 2

This embodiment relates to a method in which a base station and a terminal share AI/ML model-related information for deriving a second precoding matrix. AI/ML model-related information, as described above, may include AI/ML model configuration information and/or an AI/ML model parameter.

For example, AI/ML model-related information may include at least one of the number of convolution layers, the number of hidden layers, whether to perform padding, a padding value, a padding size, whether to perform pooling or a pooling type. Here, the number of convolution layers may also be defined by including an input layer and/or an output layer. Whether to perform padding/a padding value/a padding size/whether to perform pooling/a pooling type, etc. may be configured/indicated/defined/reported for all layers, each layer, and/or a specific layer, respectively.

Additionally or alternatively, AI/ML model-related information may include at least one of the number of kernels, a size of a kernel (e.g., 1D and/or 2D), an activation function of each layer/kernel, a stride value of each layer/kernel, weight values of a kernel, a combination of weight values or a bias value of each layer/kernel. Here, variables for a kernel/a weight may be configured/indicated/defined/reported for all layers, each layer, all kernels, a specific layer, each kernel and/or a specific kernel, respectively.

Additionally or alternatively, AI/ML model-related information may include at least one of a loss function type or an optimizer type.

Among the examples of AI/ML model-related information described above, partial information, a combination of partial information and/or the entire information may be reported/configured/indicated/defined.

In examples described above, when a base station configures/indicates to a terminal the AI/ML model-related information of a base station (or AI/ML model-related information assumed by a base station, or AI/ML model-related information assumed by a terminal), it may be configured/indicated through L1 signaling (e.g., DCI/UCI), L2 signaling (e.g., MAC CE) or RRC signaling.

In examples described above, when a terminal reports to a base station the AI/ML model-related information of a terminal (or AI/ML model-related information assumed by a terminal), it may be reported in at least one of (or together with) terminal capability information or CSI report.

In examples described above, known data (e.g., a known signal/sequence, etc.) for a terminal to derive AI/ML model-related information may be transmitted from a base station to a terminal. For example, a terminal may perform training for an AI/ML model based on known data.

In examples described above, in order to define AI/ML model-related information, a type for at least one AI/ML algorithm/model/module may be defined, and information about a specific type may be configured/indicated to a terminal and/or may be reported to a base station.

In examples described above, AI/ML model-related information corresponds to an example for performing AI/ML-enhanced CSI feedback, and it does not limit a scope of the present disclosure. Accordingly, methods for performing AI/ML-enhanced CSI feedback based on AI/ML model-related information different from examples described above may also be included in a scope of the present disclosure.

### Embodiment 3

This embodiment relates to a method for configuring/indicating which CQI should be reported (i.e., a report quantity) to a terminal for a first precoding matrix and a first CQI derived based on a first precoding matrix, and a second precoding matrix and a second CQI derived based on a second precoding matrix.

For example, all of a PMI, a first CQI and a second CQI for a first precoding matrix may be reported.

Additionally or alternatively, a PMI precoding matrix index (PMI) and a second CQI for a first precoding matrix may be reported.

Additionally or alternatively, a second CQI may be reported together in CSI report such as a PMI, etc. or may be reported separately from CSI report such as a PMI, etc. (e.g., at an independent time point).

Additionally or alternatively, when a terminal reports AI/ML model-related information to a base station, a second CQI may be reported together.

Additionally or alternatively, a different report band size (e.g., a sub-band size) may be configured/indicated for a first CQI and a second CQI.

Additionally or alternatively, a second CQI may be reported as a differential value (e.g., a differential value referring to a first CQI) for at least one of SNR, SINR, CQI or MCS.

In examples described above, when a first CQI is reported, a second CQI may be reported as a differential value referring to a first CQI. For example, a first CQI may be reported simultaneously with a second CQI or within one CSI report procedure, and a first CQI may correspond to a CQI most recently reported before a second CQI is reported.

In examples described above, reported CSI (i.e., a report quantity) may be configured/indicated to a terminal through L1 signaling (e.g., DCI/UCI), L2 signaling (e.g., MAC CE) or RRC signaling.

Additionally or alternatively, a terminal may select whether to report a non-AI/ML-based first CQI or an AI/ML-based second CQI. For example, a terminal may determine whether to report enhanced codebook-based CSI based on an AI/ML model state (e.g., whether to update an AI/ML model). In addition, a terminal may report to a base station information (e.g., selection information) on whether to report which CQI (or whether to report enhanced codebook-based CSI). For example, selection information may be included in a first part when CSI report includes a plurality of parts.

### Embodiment 4

This embodiment relates to a method in which a terminal reports a request for updating AI/ML model-related information to a base station.

For example, when a terminal reports a predetermined specific value as a second CQI (e.g., the minimum value, the maximum value, etc.), a base station may interpret that it is required to update AI/ML model-related information (e.g., an AI/ML model configuration value and/or an AI/ML model parameter).

Additionally or alternatively, when a combination of a second CQI and another CSI (e.g., CRI/RI/PMI, etc.) has a specific value, it may correspond to a request for updating AI/ML model-related information.

Additionally or alternatively, when a second CQI (and a combination with another CSI) has a specific value, it may correspond to a request for transmission of a new training signal. A base station may provide a new training signal to a terminal accordingly.

### Embodiment 5

This embodiment relates to a method in which a network configures/indicates whether to report enhanced codebook-based CSI (e.g., a second CQI) to a terminal.

For example, when receiving report information corresponding to an update request for AI/ML model-related information from a terminal, a base station may be configured not to perform (i.e., to turn off) report of enhanced codebook-based CSI (e.g., a second CQI) to a terminal.

In examples described above, whether to report enhanced codebook-based CSI may be configured/indicated to a terminal through L1 signaling (e.g., DCI/UCI), L2 signaling (e.g., MAC CE) or RRC signaling.

Based on examples described above, enhanced codebook-based CSI (e.g., a second precoding matrix calculated based on a codebook-based first precoding matrix and AI/ML model-related information, and a second CQI calculated based on a second precoding matrix) may be different in the necessity of report according to how well an AI/ML model configuration value and an AI/ML model parameter of a base station and a terminal are configured (or updated).

For example, when a terminal obtains an accurate AI/ML model configuration value and an AI/ML model parameter through sufficient training, and reports a second CQI to a base station to ensure that a base station and a terminal may derive a second precoding matrix from a second CQI based on an accurate AI/ML model configuration value and an AI/ML model parameter, scheduling and data transmission more suitable for a terminal may be performed based on a second precoding matrix and a second CQI.

When an AI/ML model configuration value and an AI/ML model parameter are not suitable for a changed channel environment due to a factor including a change in a wireless channel environment between a base station and a terminal, an enhanced codebook-based second precoding matrix and second CQI may not contribute to improving the performance of a wireless communication system. In this case, it may be desirable for a base station to perform scheduling and data transmission based on a codebook-based first precoding matrix and first CQI until an accurate AI/ML model configuration value and an AI/ML model parameter are updated. In this case, if a terminal is configured to report a second CQI to a base station, a terminal processing burden and CSI overhead for deriving a second CQI may increase, reducing system efficiency. Accordingly, in order to prevent this situation, whether to report a second CQI may be dynamically configured/indicated to a terminal (based on an update state of AI/ML model-related information).

General Device to which the Present Disclosure May be Applied

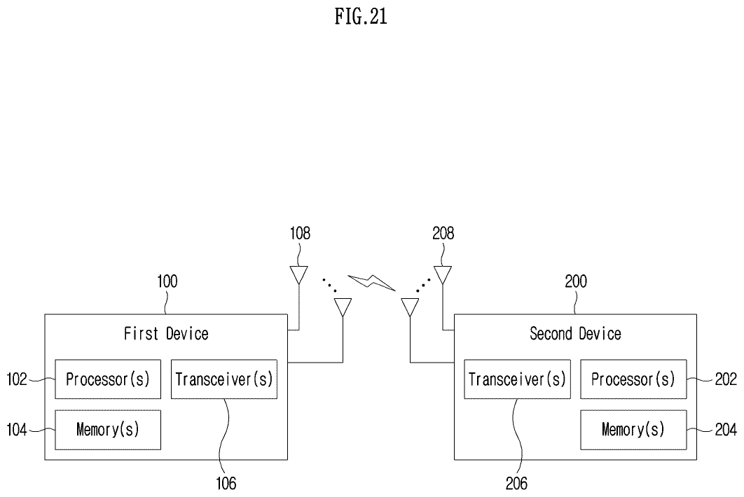

FIG. 21 illustrates a block diagram of a wireless communication device according to an embodiment of the present disclosure.

In reference to FIG. 21, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs(Application Specific Integrated Circuit), one or more DSPs(Digital Signal Processor), one or more DSPDs(Digital Signal Processing Device), one or more PLDs(Programmable Logic Device) or one or more FPGAs(Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN(Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL(non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN(personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method comprising:
receiving, by a terminal from a network, at least one channel state information (CSI)-reference signal (RS); and
transmitting, by the terminal to the network, at least one CSI report including information indicating a first precoding matrix, and a channel quality indicator (CQI) based on a second precoding matrix, based on the at least one CSI-RS,
wherein the first precoding matrix is included in a set of precoding matrices defined based on at least one predetermined codebook,
wherein the second precoding matrix is determined based on the first precoding matrix and at least one artificial intelligence (AI)/machine learning (ML) model-related information.

2. The method of claim 1, wherein the second precoding matrix is determined based on at least one of:
a precoding matrix corresponding to a relatively finer granularity compared to the first precoding matrix;
a precoding matrix corresponding to a channel state after a report time point of the information indicating the first precoding matrix;
for a channel state estimated based on the at least one CSI-RS, a precoding matrix which is relatively closer compared to the first precoding matrix;
a precoding matrix derived based on an AI/ML model trained based on the channel state estimated based on the at least one CSI-RS;
information about a channel estimated based on the at least one CSI-RS; or
information about a similarity with the channel estimated based on the at least one CSI-RS.

3. The method of claim 1, wherein:
the at least one AI/ML model-related information is shared in advance between the network and the terminal,
the at least one AI/ML model-related information includes at least one of AI/ML model-related information of the network or AI/ML model-related information of the terminal.

4. The method of claim 1, wherein the at least one AI/ML model-related information includes at least one of:
at least one AI/ML model configuration information;
at least one AI/ML model parameter;
data used to derive at least one of the at least one AI/ML model configuration information or the at least one AI/ML model parameter, or
at least one AI/ML model type information.

5. The method of claim 1, wherein:
a report quantity to be included in the at least one CSI report is configured or indicated from the network to the terminal.

6. The method of claim 1, wherein the at least one CSI report includes:
a single CSI report including a first precoding matrix index (PMI) indicating the first precoding matrix, a first CQI based on the first precoding matrix, and a second CQI corresponding to the CQI based on the second precoding matrix;
a single CSI report including the first PMI and the second CQI; or
a first CSI report including the first PMI, and a second CSI report including the second CQI.

7. The method of claim 6, wherein:
the second CQI corresponds to a differential value for the first CQI,
the differential value includes a differential value for at least one of a CQI, a signal to noise ratio (SNR), a signal to interference and noise ratio (SINR), or a modulation and coding scheme (MCS).

8. The method of claim 6, wherein:
a frequency band size on which the first CQI is based and a frequency band size on which the second CQI is based are configured or indicated differently.

9. The method of claim 1, wherein:
the CQI based on the second precoding matrix is transmitted to the network along with AI/ML model-related information of the terminal.

10. The method of claim 1, wherein:
information indicating that at least one of a first CQI based on the first precoding matrix, or a second CQI corresponding to the CQI based on the second precoding matrix is included is included in the at least one CSI report.

11. The method of claim 1, wherein:
information about a request for updating the AI/ML model-related information is transmitted from the terminal to the network.

12. The method of claim 11, wherein:
based on at least one of the CQI based on the second precoding matrix, or at least one another CSI report quantity having a specific value, the request for updating the AI/ML model-related information is indicated.

13. The method of claim 11, wherein:
the information about the request for updating the AI/ML model-related information corresponds to a request for transmitting a new training signal.

14. The method of claim 11, wherein:
in response to the request for updating the AI/ML model-related information, whether to report the CQI based on the second precoding matrix from the terminal is configured or indicated by the network.

15. An apparatus comprising:
at least one transceiver, and
at least one processor coupled with the at least one transceiver,
wherein the at least one processor is configured to:
receive, through the at least one transceiver, from a network, at least one channel state information (CSI)-reference signal (RS); and
transmit, through the at least one transceiver, to the network, at least one CSI report including information indicating a first precoding matrix, and a channel quality indicator (CQI) based on a second precoding matrix, based on the at least one CSI-RS,
wherein the first precoding matrix is included in a set of precoding matrices defined based on at least one predetermined codebook,
wherein the second precoding matrix is determined based on the first precoding matrix and at least one artificial intelligence (AI)/machine learning (ML) model-related information.

16. (canceled)

17. An apparatus comprising:
at least one transceiver, and
at least one processor coupled with the at least one transceiver,
wherein the at least one processor is configured to:
transmit, through the at least one transceiver, to a terminal, at least one channel state information (CSI)-reference signal (RS); and
receive, through the at least one transceiver, from the terminal, at least one CSI report including information indicating a first precoding matrix, and a channel quality indicator (CQI) based on a second precoding matrix, based on the at least one CSI-RS,
wherein the first precoding matrix is included in a set of precoding matrices defined based on at least one predetermined codebook,
wherein the second precoding matrix is determined based on the first precoding matrix and at least one artificial intelligence (AI)/machine learning (ML) model-related information.

18.-19. (canceled)
